(19) United States
(12) Patent Application Publication
(10) Pub. No.: US 2012/0281770 A1
(43) Pub. Date: Nov. 8, 2012

(54) REAL-SENSE COMMUNICATION TERMINAL AND REAL-SENSE COMMUNICATION METHOD USING THE SAME

(75) Inventor: Young-il Kim, Daejeon (KR)

(73) Assignee: ELECTRONICS AND TELECOMMUNICAIONS RESEARCH INSTITUTE, Daejeon (KR)

(21) Appl. No.: 13/515,112

(22) PCT Filed: Jul. 29, 2010
(86) PCT No.: PCT/KR2010/004990

§ 371 Date: Jun. 11, 2012

(30) Foreign Application Priority Data
Dec. 11, 2009 (KR) 10-2009-0123310
Mar. 31, 2010 (KR) 10-2010-0029301

(51) Int. Cl. H04N 7/24; H04W 4/20

(52) U.S. Cl. 375/240.25; 370/328; 375/E07.027

(57) ABSTRACT

A real-sense communication terminal may include: a sense communication sensor to sense information for a real-sense communication; a sense communication signal converting device to convert the sense information to a sense communication signal; a metadata processor to convert the sense communication signal to a metadata form of a transport stream; an image data processor to receive image data and to encode the received image data to be suitable for the transport stream; and a multiplexer processor to multiplex the encoded image data and the sense communication signal of the metadata form, and to thereby transmit the image data and the sense communication signal to a base station.

### TECHNICAL FIELD

The present invention relates to a real-sense communication terminal and a real-sense communication method using the same.

### BACKGROUND ART

A mobile phone that is a necessity of contemporary people corresponds to an important device of transmitting and receiving required image and data information at any place, and thus is widely being used.

Data transmitted and received via the mobile phone generally includes wideband multimedia data ranging from a message to an image. Various wired/wireless transmission technologies have been developed for the mobile phone to transmit and receive the wideband multimedia data.

Further from the technology of transmitting and receiving the wideband multimedia data, research of the current mobile phone is attempting a real-sense communication of providing sense information such as a tactile sense, an olfactory sense, a gustatory sense, and the like for personal broadcasting.

However, the real-sense communication is so far not applied to a portable terminal carried by a user and used for communication.

### DISCLOSURE

### Technical Problem

The present invention has been made in an effort to provide a real-sense communication terminal having advantages of transmitting sense data as a metadata form in an Internet protocol television (IPTV) network, and a real-sense communication method using the same.

### Technical Solution

An exemplary embodiment of the present invention provides a real-sense communication method, including: sensing and receiving, from a sense communication sensor, sense information for a real-sense communication when the real-sense communication terminal generates image data; datalizing the received sense information to thereby load the sense data in a stream form, converting the sense data to a metadata form of a transport stream, and encoding the image data to be suitable for the transport stream; and multiplexing the sense data of the metadata form and the encoded image data to thereby transmit the sense data and the image data to a base station.

Another embodiment of the present invention provides a real-sense communication method, including: extracting a transport stream from packet data received from a base station; separating image data and metadata from the extracted transport stream and then separating the transport stream into the sense data and the image data; and converting the sense data to a sense communication signal and then outputting the sense communication signal as a sense signal enabling a user to sense, and decoding and outputting the image data.

Yet another embodiment of the present invention provides a real-sense communication terminal, including: a sense communication sensor to sense information for a real-sense communication; a sense communication signal converting device to convert the sense information to a sense communication signal; a metadata processor to convert the sense communication signal to a metadata form of a transport stream; an image data processor to receive image data and to encode the received image data to be suitable for the transport stream; and a multiplexer processor to multiplex the encoded image data and the sense communication signal of the metadata form, and to thereby transmit the image data and the sense communication signal to a base station.

### Advantageous Effects

According to embodiments of the present invention, it is possible to realize realistic broadcasting by transmitting and receiving sense data, and by configuring a real-sense communication.

In addition, when a real-sense communication is applied to an IPTV terminal, it is possible to create an IPTV business model through activation of an IPTV.

Further, since it is possible to receive sense information and to transfer the sense data for personal broadcasting, it is possible to be provided with a personalized sensing communication.

### DESCRIPTION OF THE DRAWINGS

FIG. 1 is a block diagram illustrating an internal configuration of a real-sense communication terminal according to an exemplary embodiment of the present invention;

FIG. 2 is a flowchart illustrating a downlink operation of transmitting sense data from a base station to a real-sense communication terminal according to an exemplary embodiment of the present invention;

FIG. 3 is a flowchart illustrating an uplink operation of transmitting sense data from a real-sense communication terminal to a base station according to an exemplary embodiment of the present invention; and

FIG. 4 is a diagram illustrating a packetized elementary stream (PES) including sense information according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In specification, In addition, unless explicitly described to the contrary, the word “comprise” and variations such as “comprises” or “comprising”, will be understood to imply the inclusion of stated elements but not the exclusion of any other elements.

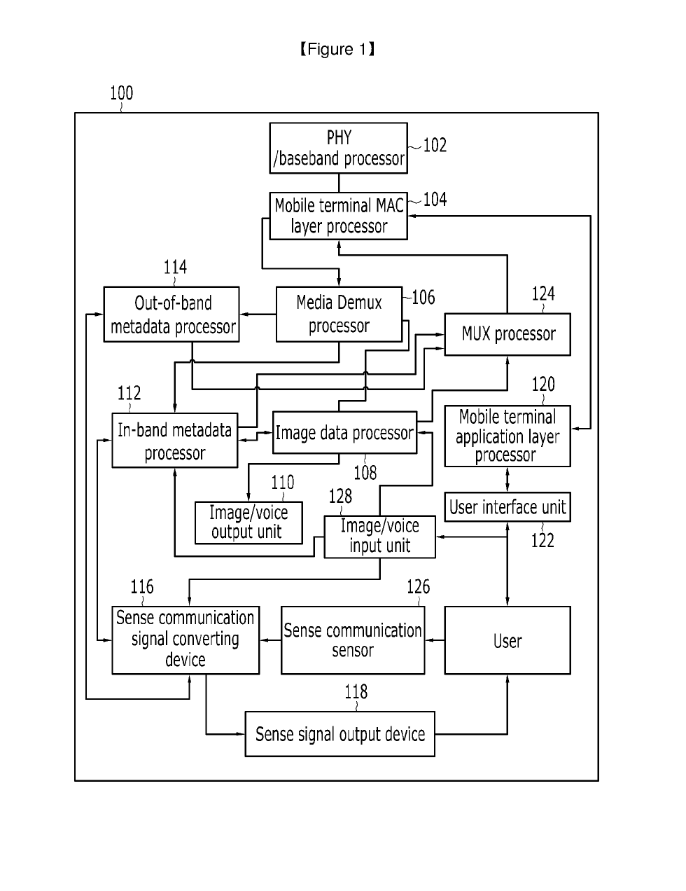

FIG. 1 is a block diagram illustrating an internal configuration of a real-sense communication terminal according to an exemplary embodiment of the present invention.

According to an exemplary embodiment of the present invention, a real-sense communication terminal 100 may include a physical layer (PHY)/baseband processor 102, a mobile terminal media access control (MAC) layer processor 104, a media demultiplexer (DEMUX) processor 106, an image data processor 108, an image/voice output unit 110, an in-band metadata processor 112, an out-of-band metadata processor 114, a sense communication signal converting device 116, a sense signal output device 118, a mobile terminal application layer processor 120, and a user interface unit 122.

The PHY/baseband processor 102 may demodulate a wireless signal received from a base station, and transmit an image signal and data to the mobile terminal MAC layer processor 104.

The mobile terminal MAC layer processor 104 may extract a packet from data received from the PHY/baseband processor 102, and thereby restore a moving picture experts group (MPEG) image data transport stream (TS).

The media demultiplexer processor 106 may receive the MPEG image data transport stream (TS) from the mobile terminal MAC layer processor 104 and thereby separate the received MPEG image data transport stream into metadata and image data. Hereinafter, the MPEG image data transport stream is referred to as “TS” for ease of description. Also, metadata indicates data required to play image and voice data in an IPTV system, and other application data.

Here, the TS may cut a packetized elementary stream (PES) 200 that is a transmission form of image and voice MPEG based on a 184-byte unit and then add a 4-byte header and then may configure at least one voice and image as a single stream.

The media demultiplexer processor 106 may extract in-band metadata existing in the TS and then transmit the extracted in-band metadata to the in-band metadata processor 112. The media demultiplexer processor 106 may extract out-of-band metadata from another channel and then transmit the extracted out-of-band metadata to the out-of-band metadata processor 114. The media demultiplexer processor 106 may extract image data and then transmit the extracted image data to the image data processor 108. Here, the in-band metadata corresponds to data included in a TS consisting of an image and a voice in an IPTV broadcasting program and thus may include control information required to play the image and the voice of the corresponding broadcasting program. Also, the out-of-band metadata indicates data transmitted via a TS of another channel in addition to the TS of the corresponding broadcasting program.

The image data processor 108 may decode image data extracted by the media demultiplexer processor 106.

The image/voice output unit 110 may output the decoded image data of the image data processor 108 and the voice.

The in-band metadata processor 112 may separate sense data from the in-band metadata received from the media demultiplexer processor 106 into a tactile signal, an olfactory signal, a gustatory signal, and a visual signal, and then may transmit the separated sense data to the sense communication signal converting device 116.

The out-of-band metadata processor 114 may separate sense data from the out-of-band metadata received from the media demultiplexer processor 106 into a tactile signal, an olfactory signal, a gustatory signal, and a visual signal and then may transmit the separated sense data to the sense communication signal converting device 116.

The sense communication signal converting device 116 may convert, to a sense communication signal, the sense data received from the in-band metadata processor 112 or the out-of-band metadata processor 114.

The sense signal output device 118 may output the converted sense communication signal as a sense signal enabling a user to sense.

An image signal generated by the real-sense communication terminal 100 may be input into an image/voice input unit 128, be encoded to be suitable for a TS in the image data processor 108, be transmitted to a multiplexer processor 124, be multiplexed with sense data converted to metadata, be transmitted to the mobile terminal MAC layer processor 104, and then be transmitted to the base station via the PHY/baseband processor 102.

The sense communication signal extracted by the sense communication signal converting device 116 may be converted to a metadata form in the in-band metadata processor 112 or the out-of-band metadata processor 114 and then be transmitted to the multiplexer processor 124.

The mobile terminal application layer processor 120 may perform a control with respect to a mobile communication PHY and a MAC layer, and a control function associated with an IPTV service for receiving an IPTV service.

The user interface unit 122 may perform a user interface function between the user and the real-sense communication terminal 100.

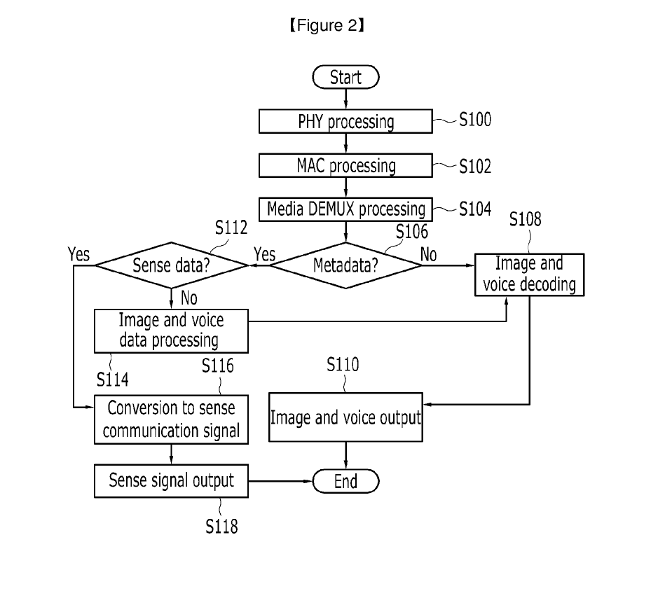

FIG. 2 is a flowchart illustrating a downlink operation of transmitting sense data from a base station to a real-sense communication terminal according to an exemplary embodiment of the present invention.

A wireless signal received from the base station may pass through a demodulation process, a channel decoding process, and a MAC protocol processing process via the PHY/baseband processor 102 and the mobile terminal MAC layer processor 104 (S100 and S102).

The media demultiplexer processor 106 may receive an MPEG image data transport stream (TS) from the mobile terminal MAC layer processor 104.

After the TS is separated into image data and metadata in the media demultiplexer processor 106 (S104), the image data may be decoded by the image data processor 108 and then be output from the image/voice output unit 110 (S106, S108, and S110). Also, in the case of the metadata, after the TS is restored to a PES 200 that is a transmission form of an MPEG in the in-band metadata processor 112 or the out-of-band metadata processor 114, the PES may be separated into sense data and image and voice data (S112).

The sense data may be converted to a sense communication signal in the sense communication signal converting device 116, and be output as a sense signal that may be felt by a user via the sense signal output device 118 (S112, S116, and S118).

The image and voice data may be used for an image and voice decoding process in the image data processor 108 (S112 and S114).

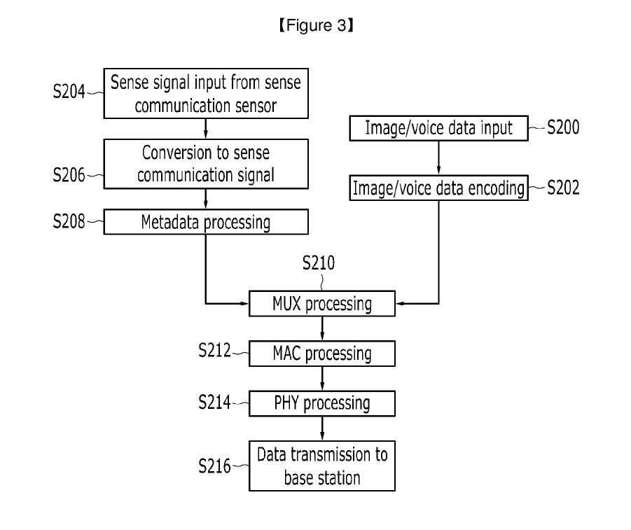

FIG. 3 is a flowchart illustrating an uplink operation of transmitting sense data from a real-sense communication terminal to a base station according to an exemplary embodiment of the present invention.

Image data generated in the real-sense communication terminal 100 may be input by the image/voice input unit 128, and be encoded to image data and voice data to be suitable for a TS by the image data processor 108 (S200 and S202).

After the sense signal is input from a sense communication sensor 126, the sense signal may be converted to the sense communication signal by the sense communication signal converting device 116 (S204 and S206).

The in-band metadata processor 112 or the out-of-band metadata processor 114 may datalize the sense communication signal to thereby load the sense communication signal in a PES 200 that is a transmission form of an MPEG, and may convert the sense communication signal to a metadata form of a TS for a real-sense communication to thereby transmit the sense communication signal of the metadata form to the multiplexer processor 124 (S208).

The multiplexer processor 124 may perform a multiplexing process with respect to metadata of the TS, the encoded image data, and voice data (S210).

### DeletedTexts

A signal passing through the multiplexing process may be processed to be suitable for a mobile communication MAC protocol by the mobile terminal MAC layer processor 104 and then be transmitted to the base station via the PHY/baseband processor 102 (S212, S214, and S216).

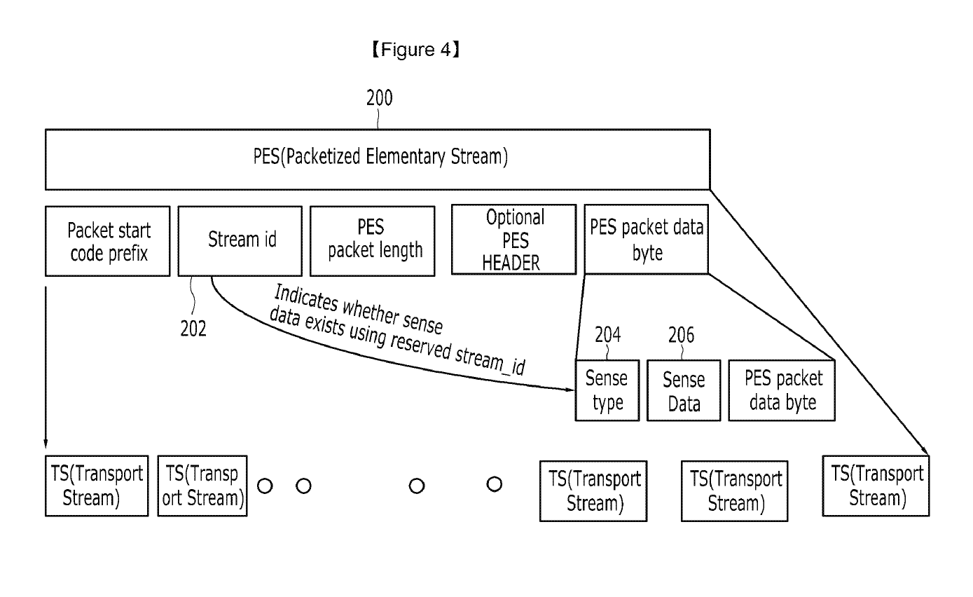

FIG. 4 is a diagram illustrating a PES including sense data according to an exemplary embodiment of the present invention.

According to an exemplary embodiment of the present invention, a PES 200 may indicate whether sense data 206 exists using a bit (1111 1100, . . . 1111 1110) reserved in a stream id 202.

When the sense data 206 is included, the stream id 202 may be set to (1111 1100, . . . 1111 1110), and the PES 200 may designate, as a bitmap form, a sense type 204 and the sense data 206 in PES packet data and thereby transmit.

The above-mentioned exemplary embodiments of the present invention are not embodied only by an apparatus and/or method. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A real-sense communication method for providing sense data in a real-sense communication terminal, comprising:
sensing and receiving, from a sense communication sensor, sense information for a real-sense communication when the real-sense communication terminal generates image data;
datalizing the received sense information to thereby load the sense data in a stream form, converting the sense data to a metadata form of a transport stream, and encoding the image data to be suitable for the transport stream; and
multiplexing the sense data of the metadata form and the encoded image data to thereby transmit the sense data and the image data to a base station.

2. The real-sense communication method of claim 1, wherein:
the encoding
datalizes the received sense information to thereby load the sense data in a packetized elementary stream (PES) that is a transmission form of a moving picture experts group (MPEG).

3. The real-sense communication method of claim 2, wherein:
The PES indicates whether the sense data exists using a bit reserved in a stream id, and includes the sense data using a packet data area.

4. A real-sense communication method for providing sense data in a real-sense communication terminal, comprising:
extracting a transport stream from packet data received from a base station;
separating image data and metadata from the extracted transport stream and then separating the transport stream into the sense data and the image data; and
converting the sense data to a sense communication signal and then outputting the sense communication signal as a sense signal enabling a user to sense, and decoding and outputting the image data.

5. The real-sense communication method of claim 4, wherein:
the sense data is classified based on an identifier of a sense form in a PES that is a transmission form of an MPEG, and thereby is loaded in a payload.

6. The real-sense communication method of claim 4, wherein:
the stream form corresponds to a PES that is a transmission form of an MPEG, and the PES indicates whether the sense data exists using a bit reserved in a stream id and includes the sense data using a packet data area.

7. A real-sense communication terminal for providing a real-sense communication service, comprising:
a sense communication sensor to sense information for a real-sense communication;
a sense communication signal converting device to convert the sense information to a sense communication signal;
a metadata processor to convert the sense communication signal to a metadata form of a transport stream;
an image data processor to receive image data and to encode the received image data to be suitable for the transport stream; and
a multiplexer processor to multiplex the encoded image data and the sense communication signal of the metadata form, and to thereby transmit the image data and the sense communication signal to a base station.

8. The real-sense communication terminal of claim 7, further comprising:
a media demultiplexer processor to extract the transport stream from packet data received from the base station, and to separate the image data and the metadata from the transport stream.

9. The real-sense communication terminal of claim 7, wherein:
the metadata processor restores the metadata to a PES, and then separates the PES into the sense data and image and voice data.

10. The real-sense communication terminal of claim 9, wherein:
the PES indicates whether the sense data exists using a bit reserved in a stream id, and includes the sense data using a packet data area.
